(19) United States
(12) Patent Application Publication
(10) Pub. No.: US 2013/0286834 A1
(43) Pub. Date: Oct. 31, 2013

(54) TRAFFIC MANAGEMENT APPARATUS FOR CONTROLLING TRAFFIC CONGESTION AND METHOD THEREOF

(71) Applicant: Won-Kyoung LEE, Daejeon-si (KR)

(72) Inventor: Won-Kyoung LEE, Daejeon-si (KR)

(73) Assignee: Electronics and Telecommunications Research Institute, Daejeon (KR)

(21) Appl. No.: 13/618,925

(22) Filed: Sep. 14, 2012

(30) Foreign Application Priority Data
Apr. 26, 2012 (KR) 10-2012-0044095

(51) Int. Cl. H04L 12/24

(52) U.S. Cl. 370/235

(57) ABSTRACT

Provided are a traffic management apparatus and method for controlling traffic congestion. The traffic management apparatus includes: a hierarchical queue configured to have a plurality of levels that are hierarchically different from each other; a Weighted Random Early Detection (WRED) management unit configured to allocate different weights to the respective levels, and to calculate a profile for each level; and a hierarchical scheduler configured to manage a packet according to each level, using the calculated profile for each level, thereby controlling traffic congestion.

### CROSS-REFERENCE TO RELATED APPLICATION

This application claims the benefit under 35 U.S.C. §119(a) of Korean Patent Application No. 10-2012-0044095, filed on Apr. 26, 2012, the entire disclosure of which is incorporated herein by reference for all purposes.

### BACKGROUND

1. Field

The following description relates to packet processing technology for a packet transport apparatus that is located in a backbone network or a core network.

2. Description of the Related Art

With increasing requirements for bandwidths, networks have been developed to have simpler and more efficient structures. Recently, the synchronous digital hierarchy (SDH)/synchronous optical network (SONET) platform of a core network and a backbone network is replaced by packet transport platform.

A packet transport apparatus is a system for transporting all kinds of services including voice service through a packet transport network. The packet transport apparatus is based on packet transport technologies of Provider Backbone Bridge Traffic Engineering (PBB-TE) and Multi Protocol Label Switching-Transport Profile (MPLS-TP).

The packet transport apparatus based on the PBB-TE or MPLS-TP provides system stability for guaranteeing the reliability of a network, service protection switching, Operation, Administration and Maintenance (OAM) of a network, etc. Packet throughput, error rate, the accuracy of QoS, the stability of OAM, times for protection switching, etc. have to be guaranteed independently.

A conventional packet transport apparatus stops transmitting packets when it receives overflow exceeding the capacity of its physical link. Furthermore, in the conventional packet transport apparatus, when control packets are transmitted together with data packets, packet throughput and error rates significantly deteriorate.

### SUMMARY

The following description relates to a traffic management apparatus capable of preventing deterioration in system performance due to traffic congestion by controlling traffic flooding and synchronization of control signals, and a method thereof.

In one general aspect, a traffic management apparatus is provided including: a hierarchical queue configured to have a plurality of levels that are hierarchically different from each other; a Weighted Random Early Detection (WRED) management unit configured to allocate different weights to the respective levels, and to calculate a profile for each level; and a hierarchical scheduler configured to manage a packet according to each level, using the calculated profile for each level, thereby controlling traffic congestion.

Parameters for calculating the profile for each level may include at least one of an Exponential Weighted Moving Average (EWMA) factor, a maximum drop probability, a minimum threshold value, and a maximum threshold value.

The WRED management unit may include: an overflow controller configured to control overflow exceeding the capacity of a link among input traffic, and to generate level-1 WRED mode activation information; a control packet desynchronizer configured to desynchronize control packets among the input traffic from data packets, and to generate level-4 WRED mode activation information; a hierarchical WRED profile calculator configured to calculate a WRED profile for the level-1 according to a control of the overflow controller, and to calculate a WRED profile for the level-4 according to a control of the control packet desynchronizer; and a hierarchical WRED constructor configured to construct WRED for all levels, based on the level-1 WRED mode activation information, the level-4 WRED mode activation information, the WRED profile for the level-1, and the WRED profile for the level-4.

The hierarchical WRED profile calculator may calculate an average queue size of the input traffic using an EWMA factor.

The hierarchical WRED profile calculator may calculate a minimum threshold value for each level.

When calculating a WRED profile for level-1 corresponding to a physical link, the hierarchical WRED profile calculator may set a minimum threshold value corresponding to a point at which loss is minimized upon the occurrence of overflow and upon 100% transmission of traffic as an optimal minimum threshold value.

When calculating a WRED profile for level-4 corresponding to a service Label Switched Path (LSP), the hierarchical WRED profile calculator may set a minimum threshold value corresponding to a point at which loss is minimized upon 100% transmission of traffic as an optimal minimum threshold value.

The hierarchical WRED profile calculator may calculate a maximum drop probability for each packet color of the input traffic.

The hierarchical WRED profile calculator may set a maximum drop probability of a green packet to 0% so that the green packet is forwarded without being dropped.

The hierarchical WRED profile calculator may set a maximum drop probability of a yellow packet to 50% so that the yellow packet is forwarded when no congestion occurs and dropped when congestion occurs.

The hierarchical WRED profile calculator may set a maximum drop probability of a red packet to 100% so that the red packet is dropped, prior to dropping of yellow packets among the input traffic, when the size of the red packet exceeds the maximum queue size, in order to prevent transmission interruption from occurring due to overflow.

The hierarchical WRED profile calculator may set a maximum threshold value to a maximum queue size in order to use the maximum capacity of a transmission link.

The hierarchical scheduler may include at least one of a congestion avoidance unit for avoiding congestion using hierarchical WRED, a traffic conditioning unit for controlling traffic through shaping, and a congestion management unit for managing traffic by congestion management through weighted fair queuing (WFQ)

In another general aspect, there is provided a method of controlling traffic congestion in a traffic management apparatus, including: allocating different weights to queue levels of the traffic management apparatus, and to calculate a WRED profile for each level; and managing a packet according to each level, using the calculated WRED profile for each level, thereby controlling traffic congestion.

The calculating of the WRED profile for each level may include, when a WRED profile for level-1 corresponding to a physical link is calculated, setting a minimum threshold value corresponding to a point at which loss is minimized upon the occurrence of overflow and upon 100% traffic transmission as an optimal minimum threshold value.

The calculating of the WRED profile for each level may include, when a WRED profile for level-4 corresponding to a service Label Switched Path (LSP) is calculated, setting a minimum threshold value corresponding to a point at which loss is minimized upon 100% transmission of traffic as an optimal minimum threshold value.

The calculating of the WRED profile for each level may include calculating a maximum drop probability for each packet color of input traffic.

Other features and aspects will be apparent from the following detailed description, the drawings, and the claims.

### BRIEF DESCRIPTION OF THE DRAWINGS

FIG. 1 is a diagram illustrating an example of a traffic management apparatus.

FIG. 2 is a graph showing Weighted Random Early Detection (WRED) profiles according to colors, calculated by a hierarchical WRED profile calculator.

FIG. 3 is a graph showing an example of a level-1 WRED profile calculated by the hierarchical WRED profile calculator.

FIG. 4 is a graph showing an example of a level-4 WRED profile calculated by the hierarchical WRED profile calculator.

FIG. 5 is a flowchart illustrating an example of a traffic congestion control method of the traffic management apparatus.

FIG. 6 is a flowchart illustrating an example of a process in which a level-1 WRED profile is calculated in the traffic management apparatus.

FIG. 7 is a flowchart illustrating an example of a process in which a level-4 WRED profile is calculated in the traffic management apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

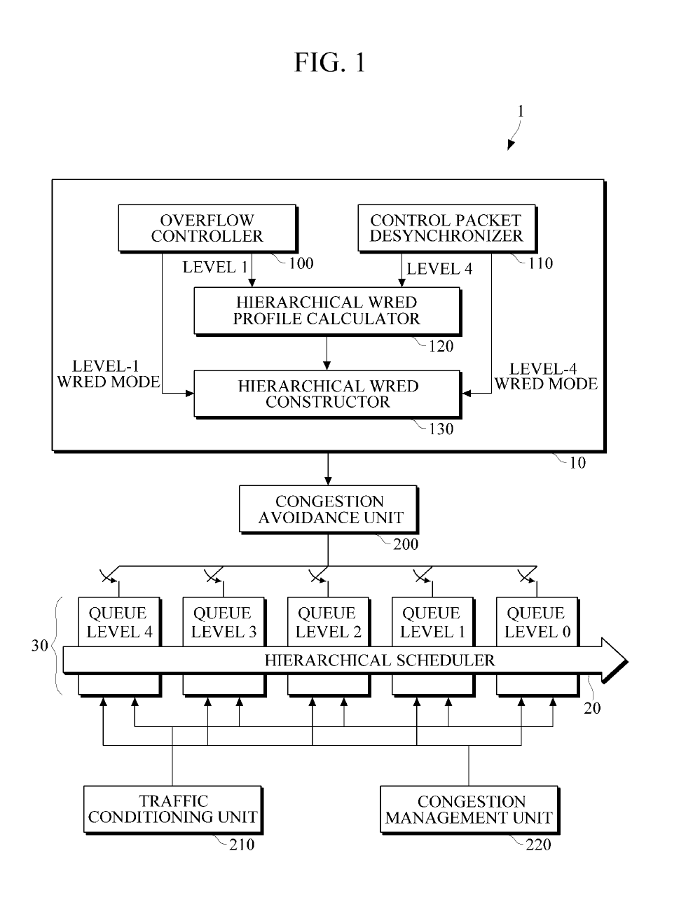

FIG. 1 is a diagram illustrating an example of a traffic management apparatus 1.

Referring to FIG. 1, the traffic management apparatus 1 includes a hierarchical queue 30, a Weighted Random Early Detection (WRED) management unit 10, and a hierarchical scheduler 20. The traffic management apparatus 1 may be installed in a packet transport apparatus.

Random Early Detection (RED) is a method of dropping randomly selected packets before a queue to which packets of input traffic are input overflows, thereby preventing the queue from overflowing. WRED which is advanced RED is a method of allocating different weights to input packets according to their traffic colors to differentiate the probabilities of dropping the packets according to the traffic colors.

The hierarchical queue 30 has a plurality of levels that are hierarchically different from each other. For example, as illustrated in FIG. 1, the levels may be hierarchically classified into level-1 corresponding to a physical port, level-2 corresponding to a logical port, level-3 corresponding to a transport Label Switched Path (LSP), and level-4 corresponding to a service LSP. Generally, a packet is classified into a service level based on information, such as the VLAN ID or IP of the packet, and the classified packet is allocated to the corresponding level queue. Thereafter, a plurality of level queues are bound, and the result is allocated to a tunnel level queue, thereby performing hierarchical control.

The WRED management unit 10 allocates different weights to the queue levels of the hierarchical queue 30 to calculate a profile for each queue level. Parameters for calculating a profile for each queue level include an exponential weighted moving average (EWMA) factor, a maximum drop probability, a minimum threshold value, and a maximum threshold value.

According to an example, the WRED management unit 10 includes an overflow controller 100, a control packet desynchronizer 110, a hierarchical WRED profile calculator 120, and a hierarchical WRED constructor 130.

When overflow exceeding a link capacity is received, the overflow controller 100 controls the overflow to prevent service failure from occurring due to interruption of packet forwarding. When overflow exceeding the capacity of a physical link occurs due to transient traffic flooding a network, packet forwarding may be interrupted. In order to avoid service failure due to such transient traffic flooding, the overflow controller 100 applies WRED to the level-1 corresponding to the physical port. The overflow controller 100 transfers a level-1 WRED profile calculation requesting signal to the hierarchical WRED profile calculator 120, generates level-1 WRED mode activation information, and transfers it to the hierarchical WRED setting unit 130 so that the hierarchical WRED constructor 130 can execute a level-1 WRED mode.

The control packet desynchronizer 110 desynchronizes control packets from data packets, and generates level-4 WRED mode activation information.

The overflow controller 100 solves the problem of data loss that may occur upon a control of overflow. Data loss caused by synchronization of data packets with control packets increases a transmission error rate, and accordingly data loss is one of the factors deteriorating traffic transmission performance, together with overflow. The control packet desynchronizer 110 desynchronizes control packets such as a continuity check message (CCM) for OAM from general packets.

Synchronization of control packets with data packets is generated in level-4 corresponding to the service LSP or in the level-3 corresponding to the transport LSP. Accordingly, the control packet desynchronizer 110 transfers a level-4/level-3 WRED profile calculation requesting signal to the hierarchical WRED profile calculator 120, generates level-4/level-3 WRED mode activation information, and transfers it to the hierarchical WRED constructor 130 so that the hierarchical WRED setting unit 130 can execute a level-4/level-3 WRED mode.

If the hierarchical WRED profile calculator 120 receives a level-1 WRED profile calculation request signal from the overflow controller 100, or a level-3/level-4 WRED profile calculation requesting signal from the control packet desynchronizer 110, the hierarchical WRED profile calculator 120 calculates a WRED profile for the corresponding level. Hereinafter, for convenience of description, calculation of a WRED profile for level-4 among level-3 and level-4 will be described, however, calculation of a WRED profile for level-3 can also be applied in the same way as the calculation of the WRED profile for level-4.

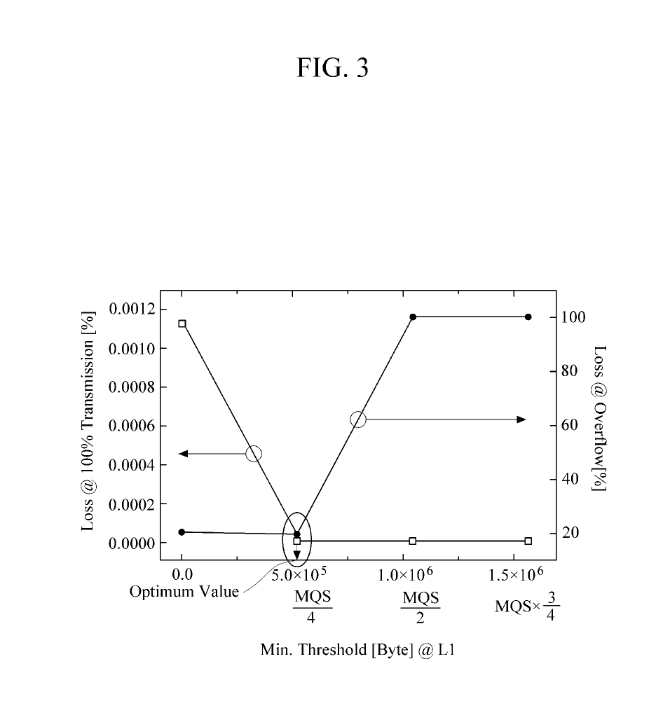

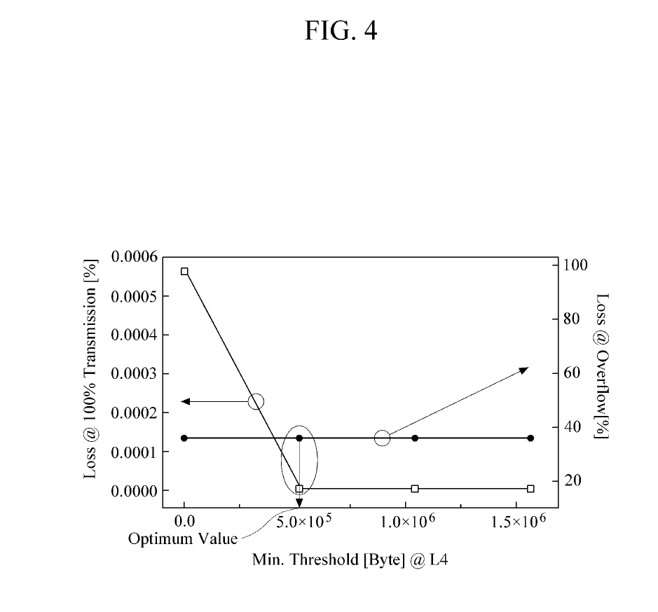

Calculation of a WRED profile for the level-1 is a method for calculating a WRED profile for controlling overflow, and calculation of a WRED profile for the level-4 is a method for calculating a WRED profile for desynchronizing control packets. An example related to calculation of a WRED profile for the level-1 will be described with reference to FIG. 3, later, and also, an example related to calculation of a WRED profile for the level-4 will be described with reference to FIG. 4, later.

The hierarchical WRED profile calculator 120 calculates an average queue size for storing an input packet, using a EWMA and a low-pass filter. A congestion avoidance unit 200 (which will be described later) of the hierarchical scheduler 20 compares the average queue size to two threshold values, that is, a minimum threshold value and a maximum threshold value. If the average queue size is smaller than the minimum threshold value, the congestion avoidance unit 200 passes the corresponding packet. Meanwhile, if the average queue size is larger than the maximum threshold value, the congestion avoidance unit 200 drops the corresponding packet. If the average queue size is between the minimum threshold value and the maximum threshold value, the congestion avoidance unit 200 drops or passes the corresponding packet according to the drop probability of the packet.

The average queue size can be calculated using the current queue size and the previous queue size, by Equation 1, below.

$$Average = Old\_average \times ( 1 - \frac{1}{{2}^{n}} ) + Current\_average \times \frac{1}{{2}^{n}} , \qquad ( 1 )$$

where n is an exponential weight factor. If the value of the exponential weight factor n is too large, the average queue size becomes equal to the previous queue size. That is, a sharp change in current queue size is not sufficiently reflected, and accordingly WRED cannot perform the function of congestion avoidance upon the occurrence of congestion since it does not respond quickly to the occurrence of congestion. On the contrary, if the n value is too small, WRED over-responds to transient traffic burst by unnecessarily dropping traffic, resulting in performance deterioration. Accordingly, the n value has to be set to a value in an appropriate range so that it has little effect either overflow or control packet desynchronization.

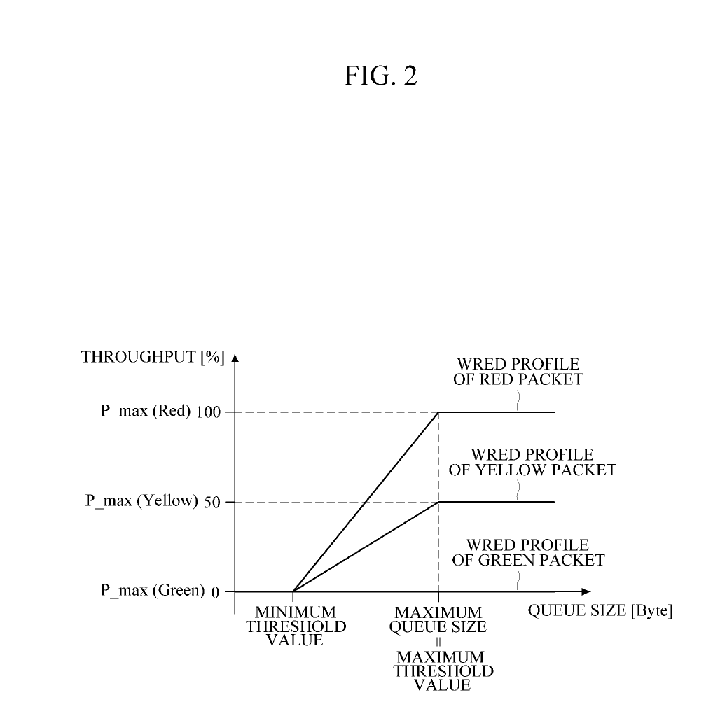

The congestion avoidance unit 200 starts to drop packets, if the average queue size is larger than the minimum threshold value. As the average queue size increases until it reaches the maximum threshold value, the packet drop probability increases linearly. The minimum threshold value has to be a sufficiently large value in order to use the maximum capacity of a transport link. If the minimum threshold value is too small, packets are unnecessarily dropped so that the capacity of the transport link cannot be sufficiently used. Also, in order to avoid synchronization between control packets and data packets, the difference between the maximum threshold value and the minimum threshold value is sufficiently great. According to an example, the hierarchical WRED profile calculator 120 calculates a minimum threshold value according to the level and color of a packet. Also, the hierarchical WRED profile calculator 120 may calculate a maximum drop probability according to the color of a packet. An example related to calculation of a maximum drop probability according to the color of a packet will be described with reference to FIG. 2, later.

The hierarchical WRED constructor 130 constructs WRED for all levels, based on level-1 WRED mode activation information, level-4 WRED mode activation information, and a WRED profile for each level.

The hierarchical WRED constructor 130 receives the level-1 WRED mode activation information from the overflow controller 100, the level-4 WRED mode activation information from the control packet desynchronizer 110, and the WRED profile for each level from the hierarchical WRED profile calculator 120. Then, the hierarchical WRED constructor 130 constructs WRED for all levels using the received information. Here, constructing WRED means an operation of setting parameter values for executing a WRED algorithm in the congestion avoidance unit 200 through a driver API, wherein the parameter values include the on/off value of WRED for each level, maximum and minimum threshold values, drop probabilities according to colors, etc.

The hierarchical scheduler 20 controls traffic congestion by managing packets for each level using the WRED profile calculated by the WRED management unit 10. The hierarchical scheduler 20 may include the congestion avoidance unit 200, a traffic conditioning unit 210, and a congestion management unit 220.

The congestion avoidance unit 200 avoids congestion according the WRED profile calculated by the WRED management unit 10. The traffic conditioning unit 210 controls traffic through shaping. The shaping is one of the methods for guaranteeing QoS. The congestion management unit 220 manages traffic by congestion management through weighted fair queuing (WFQ).

FIG. 2 is a graph showing WRED profiles according to colors, calculated by a hierarchical WRED profile calculator 120.

Referring to FIGS. 1 and 2, the hierarchical WRED profile calculator 120 sets the maximum threshold values of green, yellow, and red packets as maximum queue sizes, in order to use the maximum capacity of a transport link. The green packet is forwarded without being dropped. The yellow packet is forwarded when no congestion occurs and dropped when congestion occurs. The red packet has to be dropped, prior to dropping of yellow packets among input packets, when its size exceeds the maximum queue size, in order to prevent transmission interruption due to overflow.

The hierarchical WRED profile calculator 120 can set a value of an average moving factor of each of the green, yellow, and red packets as an arbitrary value so long as the value does not affect performance. The arbitrary value may be between 5 and 20, however, the value is not limited to a value in the range between 5 and 20.

According to an example, as shown in FIG. 2, the hierarchical WRED profile calculator 120 sets a maximum drop probability of the green packet to 0% (P_max (Green)=0%) so that it is forwarded without being dropping. Also, the hierarchical WRED profile calculator 120 sets a maximum drop probability of the yellow packet to 50% (P_max (Yellow)=50%) so that it is forwarded when no congestion occurs and dropped when congestion occurs. Also, the hierarchical WRED profile calculator 120 sets a maximum drop probability of the red packet to 100% (P_max (Red)=100%) so that the red packet is dropped, prior to the dropping of yellow packets among input packets, when its size exceeds the maximum queue size, in order to prevent transmission interruption due to overflow.

FIG. 3 is a graph showing an example of a level-1 WRED profile calculated by the hierarchical WRED profile calculator 120.

Referring to FIGS. 1 and 3, when the hierarchical WRED profile calculator 120 constructs a WRED profile for the level-1 corresponding to a physical link, the hierarchical WRED profile calculator 120 sets a minimum threshold value corresponding to a point at which loss is minimized upon the occurrence of overflow and upon 100% transmission of traffic, to an optimal minimum threshold value. That is, as shown in FIG. 3, a minimum threshold value corresponding to a point at which a packet loss rate line (denoted by “”) regarding overflow intersects a packet loss rate line (denoted by “∘”) regarding 100% transmission of traffic is set to an optimal minimum threshold value.

The minimum threshold value may be an arbitrary value between 0 and the maximum threshold value corresponding to the maximum queue size. Since the difference between the maximum and minimum threshold values needs to be great in order to avoid synchronization, the minimum threshold value may be set to 0. However, if the minimum threshold value is 0, as shown in FIG. 3, the problem of transmission interruption due to overflow is solved, but loss of 0.0012% is generated upon 100% transmission of traffic in consideration of overhead. The smaller the difference between the minimum and maximum threshold values, the less loss upon 100% transmission of traffic, but transmission interruption due to overflow still occurs. Accordingly, as shown in FIG. 3, a minimum threshold value corresponding to a point at which no loss is generated upon 100% transmission of traffic while no transmission interruption due to overflow occurs is set to an optimal minimum threshold value. In the example of FIG. 3, the optimal minimum threshold value is ¼ of the maximum queue size (MQS). Meanwhile, the example of setting the minimum threshold value for the level-1 may be applied to green, yellow, and red packets in the same ways.

FIG. 4 is a graph showing an example of a level-4 WRED profile calculated by the hierarchical WRED profile calculator 120.

Referring to FIGS. 1 and 4, when the hierarchical WRED profile calculator 120 calculates a WRED profile for the level-4 corresponding to a service LSP, the hierarchical WRED profile calculator 120 sets a minimum threshold value corresponding to a point at which loss is minimized upon 100% transmission of traffic, to an optimal minimum threshold value. That is, as shown in FIG. 4, a minimum threshold value corresponding to a minimum loss rate point on a packet loss rate line (denoted by “∘”) regarding 100% transmission of traffic, regardless of a packet loss rate line (denoted by “”) regarding overflow, is set to an optimal minimum threshold value.

Unlike the loss graph for level-1 of FIG. 3, the loss graph for the level-1 of FIG. 4 shows that a change of a minimum threshold value for level-4 little affects loss regarding overflow. Accordingly, overflow can be appropriately controlled by level-1 corresponding to the physical link. Loss due to synchronization of control packets with data packets is maximum (0.0006%) when the minimum threshold value for the level-4 is 0. In the current example, when the minimum threshold value is greater than ¼ of the maximum queue size, no loss is generated upon 100% transmission of traffic. Accordingly, the hierarchical WRED profile calculator 120 sets a minimum threshold value at which no loss is generated while maintaining the relatively great difference between the maximum and minimum threshold values, to an optimal minimum threshold value. Meanwhile, the example of setting the minimum threshold value for the level-4 may be applied to green, yellow, and red packets in the same ways.

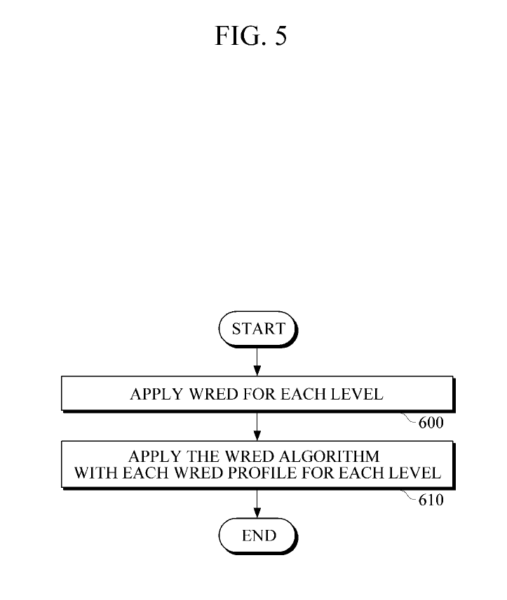

FIG. 5 is a flowchart illustrating an example of a traffic congestion control method of the traffic management apparatus 1.

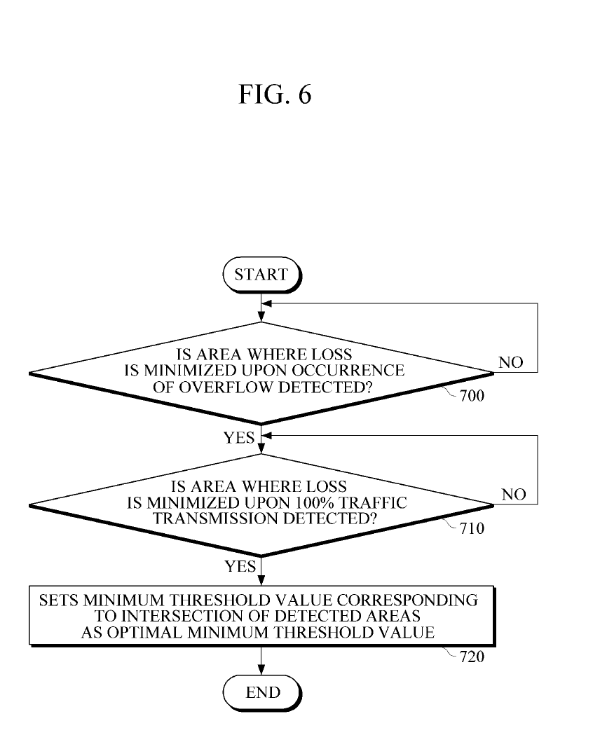

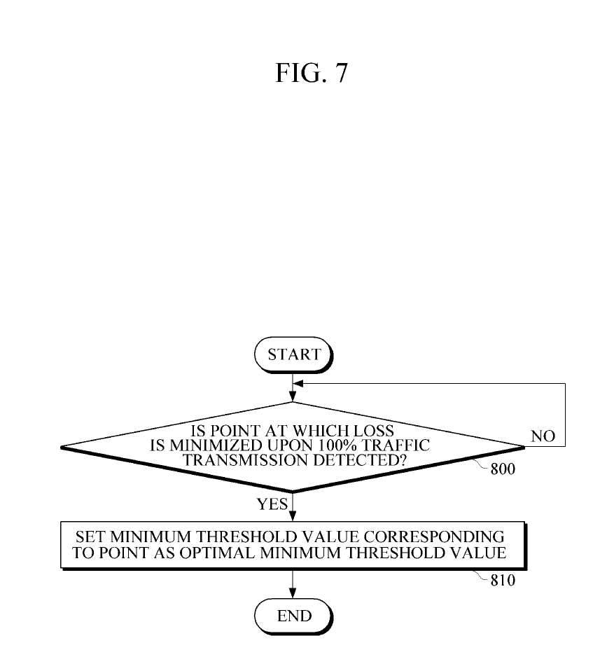

Referring to FIGS. 1 and 5, the traffic management apparatus 1 allocates different weights to the respective queue levels, and calculates a WRED profile for each queue level (600). Details on calculation of the WRED profile for each queue level will be described with reference to FIGS. 6 and 7, later. Then, the traffic management apparatus 1 manages packets for each level using the WRED profile, thereby controlling traffic congestion (610).

FIG. 6 is a flowchart illustrating an example of a process in which a level-1 WRED profile is calculated in the traffic management apparatus 1.

Referring to FIGS. 1 and 6, in the case of calculating a profile for level-1 corresponding to a physical link, the traffic management apparatus 1 detects an area where loss is minimized upon occurrence of overflow (700). Then, the traffic management apparatus 1 detects an area where loss is minimized upon 100% transmission of traffic (710). Next, the traffic management apparatus 1 sets a minimum threshold value corresponding to a point at which the area where loss is minimized upon the occurrence of overflow intersects the area where loss is minimized upon 100% transmission of traffic, to an optimal minimum threshold value (720).

FIG. 7 is a flowchart illustrating an example of a process in which a level-4 WRED profile is calculated in the traffic management apparatus 1.

Referring to FIGS. 1 and 7, in the case of calculating a profile for level-4 corresponding to a service LSP, the traffic management apparatus 1 detects a point at which loss is minimized upon 100% transmission of traffic (800), and sets a minimum threshold value corresponding to the point as an optimal minimum threshold value (810).

Therefore, according to the examples described above, by preventing service interruptions due to traffic congestion and suppressing an increase in error rate due to synchronization of control packets with data packets in the packet transport apparatus, it is possible to efficiently use the capacity of a link, and improve the stability and performance of the packet transport apparatus.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A traffic management apparatus comprising:
a hierarchical queue configured to have a plurality of levels that are hierarchically different from each other;
a Weighted Random Early Detection (WRED) management unit configured to allocate different weights to the respective levels, and to calculate a profile for each level; and
a hierarchical scheduler configured to manage a packet according to each level, using the calculated profile for each level, thereby controlling traffic congestion.

2. The traffic management apparatus of claim 1, wherein parameters for calculating the profile for each level include at least one of an exponential weighted moving average (EWMA) factor, a maximum drop probability, a minimum threshold value, and a maximum threshold value.

3. The traffic management apparatus of claim 1, wherein the WRED management unit comprises:
an overflow controller configured to control overflow exceeding a capacity of a link among input traffic, and to generate level-1 WRED mode activation information;
a control packet desynchronizer configured to desynchronize control packets among the input traffic from data packets, and to generate level-4 WRED mode activation information;
a hierarchical WRED profile calculator configured to calculate a WRED profile for the level-1 according to a control of the overflow controller, and to calculate a WRED profile for the level-4 according to a control of the control packet desynchronizer; and
a hierarchical WRED constructor configured to construct WRED for all levels, based on the level-1 WRED mode activation information, the level-4 WRED mode activation information, the WRED profile for the level-1, and the WRED profile for the level-4.

4. The traffic management apparatus of claim 3, wherein the hierarchical WRED profile calculator calculates an average queue size of the input traffic using an exponential weighted moving average (EWMA) factor.

5. The traffic management apparatus of claim 3, wherein the hierarchical WRED calculator calculates a minimum threshold value for each level.

6. The traffic management apparatus of claim 5, wherein when calculating a WRED profile for level-1 corresponding to a physical link, the hierarchical WRED calculator sets a minimum threshold value corresponding to a point at which loss is minimized upon occurrence of overflow and upon 100% transmission of traffic as an optimal minimum threshold value.

7. The traffic management apparatus of claim 5, wherein when calculating a WRED profile for level-4 corresponding to a service Label Switched Path (LSP), the hierarchical WRED calculator sets a minimum threshold value corresponding to a point at which loss is minimized upon 100% transmission of traffic as an optimal minimum threshold value.

8. The traffic management apparatus of claim 3, wherein the hierarchical WRED profile calculator calculates a maximum drop probability for each packet color of the input traffic.

9. The traffic management apparatus of claim 8, wherein the hierarchical WRED profile calculator sets a maximum drop probability of a green packet to 0% so that the green packet is forwarded without being dropped.

10. The traffic management apparatus of claim 8, wherein the hierarchical WRED profile calculator sets a maximum drop probability of a yellow packet to 50% so that the yellow packet is forwarded when no congestion occurs and dropped when congestion occurs.

11. The traffic management apparatus of claim 8, wherein the hierarchical WRED profile calculator sets a maximum drop probability of a red packet to 100% so that the red packet is dropped, prior to dropping of yellow packets among the input traffic, when a size of the red packet exceeds a maximum queue size, in order to prevent transmission interruption from occurring due to overflow.

12. The traffic management apparatus of claim 3, wherein the hierarchical WRED profile calculator sets a maximum threshold value to a maximum queue size in order to maximally use a capacity of a transmission link.

13. The traffic management apparatus of claim 1, wherein the hierarchical scheduler compares an average queue size of a received packet to a minimum threshold value and a maximum threshold value, using the profile for each level, calculated by the WRED management unit, passes the packet if the average queue size of the packet is smaller than the minimum threshold value, drops the packet if the average queue size of the packet is larger than the maximum threshold value, and drops the packet according to a drop probability of the packet if the average queue size of the packet is between the minimum threshold value and the maximum threshold value, thereby avoiding congestion.

14. A method of controlling traffic congestion in a traffic management apparatus, comprising:
allocating different weights to queue levels of the traffic management apparatus, and to calculate a Weighted Random Early Detection (WRED) profile for each level; and
managing a packet according to each level, using the calculated WRED profile for each level, thereby controlling traffic congestion.

15. The method of claim 14, wherein the calculating of the WRED profile for each level comprises, when a WRED profile for level-1 corresponding to a physical link is calculated, setting a minimum threshold value corresponding to a point at which loss is minimized upon occurrence of overflow and upon 100% traffic transmission as an optimal minimum threshold value.

16. The method of claim 14, wherein the calculating of the WRED profile for each level comprises, when a WRED profile for level-4 corresponding to a service Label Switched Path (LSP) is calculated, setting a minimum threshold value corresponding to a point at which loss is minimized upon 100% transmission of traffic as an optimal minimum threshold value.

17. The method of claim 14, wherein the calculating of the WRED profile for each level comprises calculating a maximum drop probability for each packet color of input traffic.
